(19) United States
(12) Patent Application Publication
(10) Pub. No.: US 2014/0344358 A1
(43) Pub. Date: Nov. 20, 2014

(54) FILTERING OF CONTENT TO DISPLAY USING AN OPPORTUNITY ENGINE THAT IDENTIFIES OTHER USERS ABILITY TO INTERACT IN REAL TIME

(71) Applicant: Google Inc., Mountain View, CA (US)

(72) Inventors: Eric HC Liu, Santa Clara, CA (US); Haywai Hayward Chan, Sunnyvale, CA (US)

(73) Assignee: Google Inc., Mountain View, CA (US)

(21) Appl. No.: 13/897,958

(22) Filed: May 20, 2013

(51) Int. Cl. H04L 29/08

(52) U.S. Cl. CPC H04L 67/22
USPC 709/204

(57) ABSTRACT

This disclosure generally relates to systems and methods that facilitate identifying topic(s) from incoming data items from a plurality of data sources, identifying other data items that relate to the topic(s), identifying users that have an interest in the topic(s), identifying availability of the users, rating the topic(s), and presenting a filtered set of topics based upon the identifications and ratings.

### TECHNICAL FIELD

This disclosure generally relates to systems and methods that facilitate identifying topic(s) from incoming data items from a plurality of data sources, identifying other data items that relate to the topic(s), identifying users that have an interest in the topic(s), identifying availability of the users, rating the respective topics, and presenting a filtered set of topics based upon the identifications and ratings.

### BACKGROUND OF THE INVENTION

User are often inundated with information from a variety of sources, while interacting with client devices, such as social media, social networks, news, email, text messages, chat messages, voicemails, alerts, etc. Oftentimes, there is too much data to manually sort through, and when automatically presented, data items are often not presented at an ideal time for the user. For example, a work related posting may be presented to a user requiring live interaction with coworkers that are currently available, but is presented during non-work hours. In another example, an advertisement for a group discount in connection with dining may be presented when the user is unable interact with friends potentially interested in going to dinner.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed description of the various embodiments that follow in the disclosure.

In accordance with a non-limiting implementation, a plurality of topics are generated based upon a plurality of data items, respective availability statuses of user identities from a plurality of user identities are determined having an established relationship with each other, the topics are rated based upon at least the respective availability statuses and respective associations of the user identities with the plurality of topics, and a set of topics is selected from the plurality or topics to present to a user identity of the plurality of user identities based upon the respective ratings of the topics.

In accordance with a non-limiting implementation, a topic generation component is configured to generate a plurality of topics based upon a plurality of data items, a user availability component is configured to determine respective availability statuses of user identities from a plurality of user identities having an established relationship with each other, a topic rating component is configured to rate the topics based upon at least the respective availability statuses and respective associations of the user identities with the plurality of topics; and a topic presentation component is configured to select a set of topics from the plurality or topics to present to a user identity of the plurality of user identities based upon the respective ratings of the topics.

These and other implementations and embodiments are described in more detail below.

### BRIEF DESCRIPTION OF THE DRAWINGS

FIG. 1 illustrates a block diagram of an exemplary non-limiting system for presenting data of interest to a user identity when the user identity can interact with other user identities in real time that also have an interest in the data in accordance with an implementation of this disclosure.

FIG. 2 illustrates a block diagram of an exemplary non-limiting an opportunity engine component that generates and/or filters data for presentation to the user identities in accordance with an implementation of this disclosure.

FIG. 3 illustrates a block diagram of an exemplary non-limiting user presence component that identifies user identities that have an interest in topics and determines availability of the user identities in accordance with an implementation of this disclosure.

FIG. 4 illustrates a block diagram of an exemplary non-limiting client device associated with a user identity with a display showing a music television show and having a notification area listing topics in accordance with an implementation of this disclosure.

FIG. 5 illustrates a block diagram of an exemplary non-limiting client device associated with a user identity with a display showing a music television show and having a notification area listing data items and currently available user identities in accordance with an implementation of this disclosure.

FIG. 6 illustrates a block diagram of an exemplary non-limiting notification area associated with presenting currently available user identities, a social network posting, an advertisement, and an image of food related to the advertisement in accordance with an implementation of this disclosure.

FIG. 7 illustrates an exemplary non-limiting flow diagram for identifying topics, data items, and/or currently available user identities for presentation in accordance with an implementation of this disclosure.

FIG. 8 illustrates an exemplary non-limiting flow diagram for receiving and presenting topics, data items, and/or currently available user identities in accordance with an implementation of this disclosure.

FIG. 9 illustrates a block diagram of an exemplary non-limiting networked environment in which the various embodiments can be implemented.

FIG. 10 illustrates a block diagram of an exemplary non-limiting computing system or operating environment in which the various embodiments can be implemented.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of this disclosure may be practiced without these specific details, or with other methods, components, materials, etc. In other instances, well-known structures and devices are shown in block diagram form to facilitate describing this disclosure.

In situations in which systems and methods described herein collect personal information about users, or may make use of personal information, the users can be provided with an opportunity to control whether programs or features collect user information (e.g., information about a user's social network, social actions or activities, profession, a user's preferences, or a user's current location), or to control whether or how to receive content from the content server that may be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. The user can add, delete, or modify information about the user. Thus, the user can control how information is collected about the user and used by a server.

In accordance with various disclosed aspects, a mechanism is provided for presenting data of interest to a user when the user is able to interact with other users in real time that may also have interest in the data. For example, a user can be watching a television show and a discount offer for bowling at a local bowling alley is available. The discount offer can be presented with a list of the user's friends in the local area that are online in a social network and also have an interest in bowling. In another example, a user can be listening to music on their phone around noon, and a discount offer for lunch at a restaurant is available, as well as a posting from a friend asking if anyone is interested in lunch. The discount offer and posting can be presented along with a list of the common friends of the user and the user's friend near the restaurant that are online in a chat system. In a further example, a news article about a technology concept can be published. The news article and a list of friends who have an interest in the technology concept who also are actively engaged with their phones but are not on a phone call can be presented to the user. Thus, determinations or inferences regarding user availability as well as other users' availability and common interest are utilized to optimize dissemination and/or presentation of content to respective users to facilitate optimizing engagement.

A data item can include, for example, video, audio, image, text, or any combination thereof. Data items can be available on an intranet, internet, or can be local content. Furthermore, a user identity is a digital representation of a user in a system, for example, a user account, username, or any other suitable mechanism for representing a user in an electronic system.

With reference to the embodiments described below, an example television device is presented for illustrative purposes only. It is to be appreciated that any suitable type of client device using audio, visual, and or tactile user interfaces can be employed.

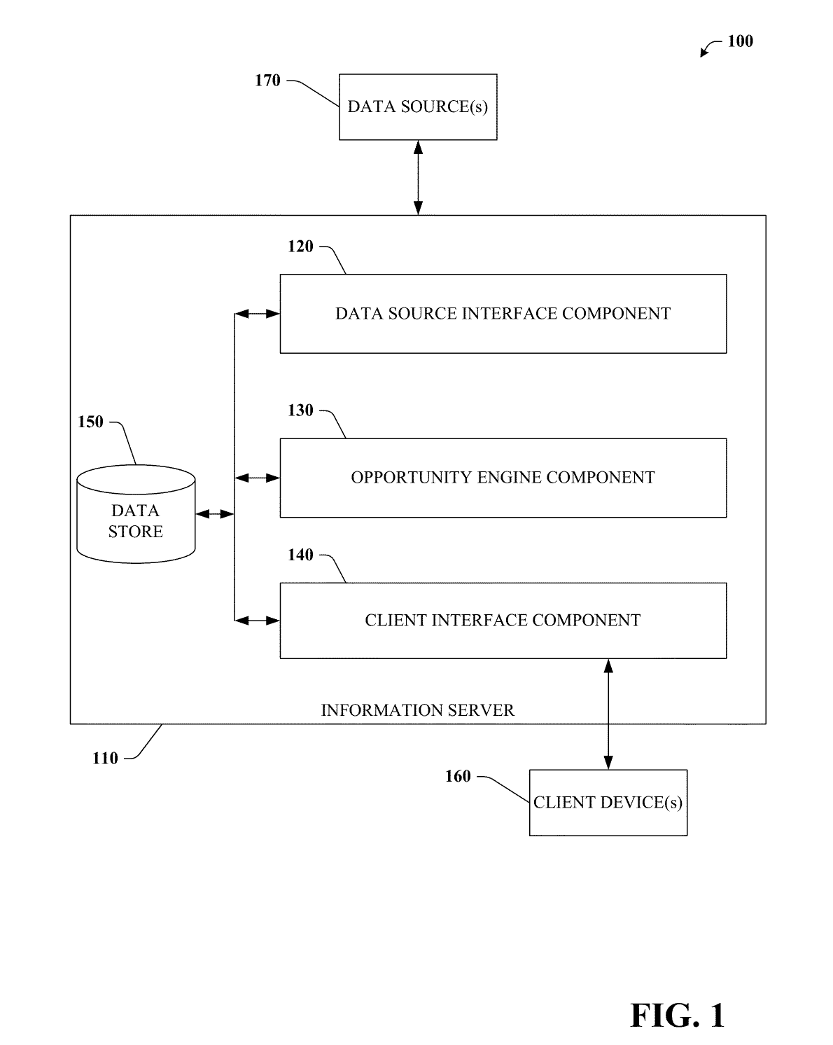

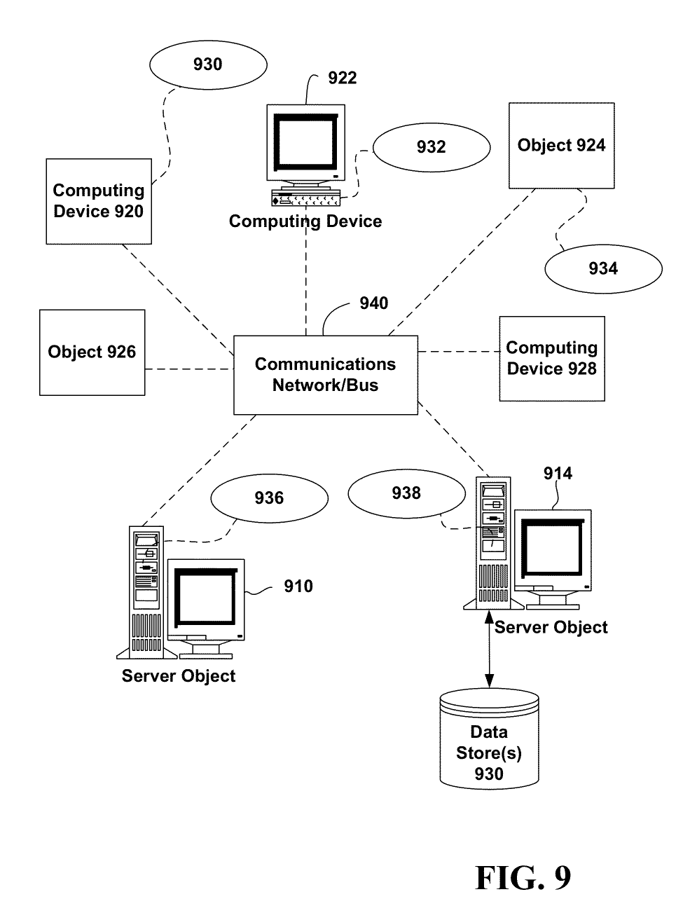

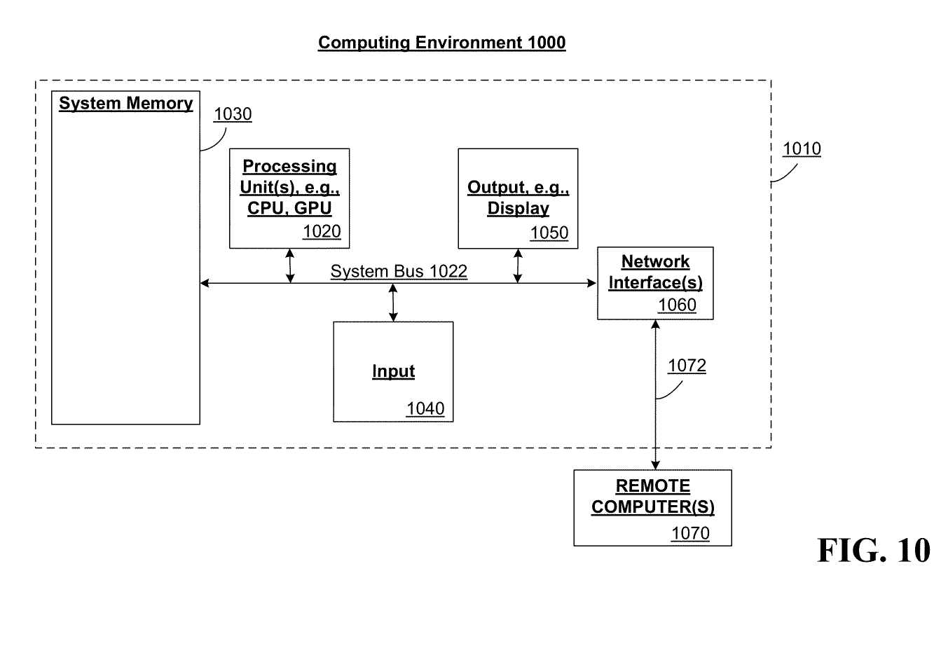

Referring now to the drawings, FIG. 1 depicts a system 100 for presenting data of interest to a user identity when the user identity can interact with other user identities in real time that also have potential or actual interest in the data. System 100 includes information server 110 that comprises data source interface component 120 that can receive data items from one or more data sources 170. It is to be appreciated that data items can be any suitable information supplied to information server 110 for potential presentation to a user identity, such as in a non-limiting example: news articles, email, chat messages, social network postings, voicemails, music, videos, images, documents, advertisements, blogs postings, subscriptions, stock quotes, or any other suitable data for presentation to the user identity. In a non-limiting example, data source 170 can include a website, server, client device, advertisement network, social network, email system, news feed, chat system, phone system, or any other suitable source from which data items can be received and/or accessed. Information server 110 also includes client interface component 140 that interacts with one or more client devices 160 to present data to user identities. While information server 110 is depicted as a distinct device in this embodiment, it is to be appreciated that in another embodiment client device 160 can act as an information server 110, thus not requiring a separate information server 110 device. Information server 110 includes an opportunity engine component 130 that generates and/or filters the data for presentation to the user identities. Additionally, information server 110 includes a data store 150 that can store data generated or received by information server 110, data source interface component 120, opportunity engine 130, client interface component 140, data source 170, and client device 160. Data store 150 can be stored on any suitable type of storage device, non-limiting examples of which are illustrated with reference to FIGS. 9 and 10.

While only one data source 170 and client device 160 are shown, it should be appreciated that information server 110 can interact with any suitable number of data sources 170 and client devices 160 concurrently. Furthermore, information server 110 and client device 160 can respectively receive input from users to control interaction with, and presentation of data, for example, using input devices, non-limiting examples of which can be found with reference to FIG. 10.

Information server 110 and client device 160, each respectively include a memory that stores computer executable components and a processor that executes the computer executable components stored in the memory, a non-limiting example of which can be found with reference to FIG. 10. Information server 110 can communicate via a wired and/or wireless network with client device 160 or data source 170.

Information server 110 or client device 160 can be any suitable type of device for generating, interacting with, receiving, accessing, and/or supplying data locally, or remotely over a wired and/or wireless communication link, non-limiting examples of include a wearable device or a non-wearable device. Wearable device can include, for example, heads-up display glasses, a monocle, eyeglasses, contact lens, sunglasses, a headset, a visor, a cap, a helmet, a mask, a headband, clothing, camera, video camera, or any other suitable device capable of recording, generating, interacting with, receiving, accessing, or supplying data that can be worn by a human or non-human user. Non-wearable device can include, for example, a mobile device, a mobile phone, a camera, a camcorder, a video camera, personal data assistant, laptop computer, tablet computer, desktop computer, server system, cable set top box, satellite set top box, cable modem, television set, monitor, media extender device, blu-ray device, DVD (digital versatile disc or digital video disc) device, compact disc device, video game system, portable video game console, audio/video receiver, radio device, portable music player, navigation system, car stereo, motion sensor, infrared sensor, or any other suitable device capable of recording, generating, interacting with, receiving, accessing, and/or supplying data. Moreover, information server 110 and client device 160 can include a user interface (e.g., a web browser or application), that can receive and present displays and content generated locally or remotely.

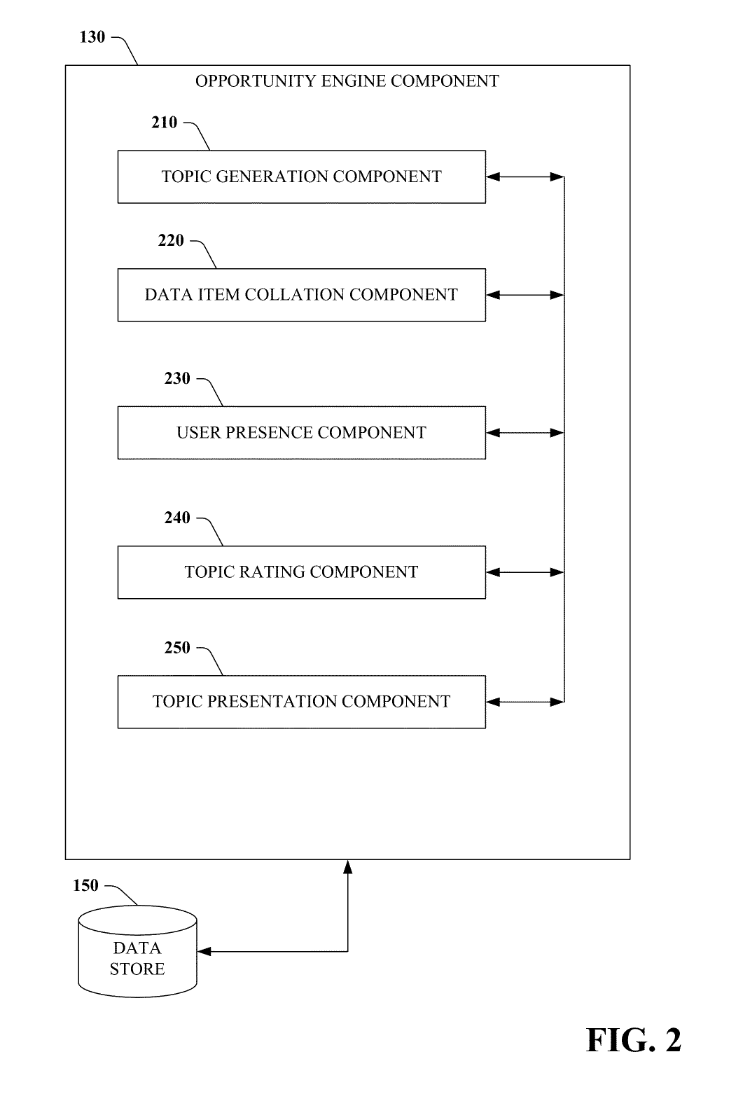

Referring to FIG. 2, opportunity engine component 130 includes topic generation component 210 that generates topics for and/or associates topics to data items associated with a user identity. Opportunity engine component 130 also includes data item collation component 220 that identifies data items to associate with a topic. Additionally, opportunity engine component 130 includes user presence component 230 that identifies user identities that have an interest in the topics, and determines availability of the user identities. Opportunity engine component 130 includes a topic rating component 240 that assigns ratings to the topics. Furthermore, opportunity engine component 130 includes topic presentation component 250 that can identify a list of topics, associated data items, and/or currently available user identities for presentation to a user identity.

Topic generation component 210 can analyze data items associated with a user identity received and/or accessed from data sources 170 to identify topics related to the data item. A user identity can receive data items from a plurality of data sources 170, such as from subscriptions, memberships, newsfeeds, emails, chat streams, or any other suitable data source. In a non-limiting example, content of, metadata associated with, and/or data derived from the data item can be examined by topic generation component 210, such as for visual, audio, or textual data that is indicative of a topic, for example, using visual, audio, or textual recognition algorithms. For example, a metadata description of the data item, such as “latest record from XYZ music artist” can indicate that the item is related to the topics “music” and “XYZ artist”. In another example, a social network posting can state “Is anyone up for steak tonight” which can indicate the topics “food”, “dinner”, and “steak”. In another non-limiting example, topic generation component 210 can perform a visual analysis to recognize objects an image, such as people, faces, clothing, buildings, cars, a stage, a venue, road signs, or any other suitable visual object that can be employed to generate data that is indicative of a topic. In a further non-limiting example, topic generation component 210 can perform an audio analysis to recognize audio signals, such as music, voices, vehicles, text, language spoken, sounds unique to a location or object, or any other suitable sound that can be employed to generate data that is indicative of a topic. In an embodiment, topic generation component 210 can employ the data that is indicative of a topic in conjunction with a predefined, dynamically determined, and/or user specified taxonomy or list of topics to associate a topic to the data item, such as in a non-limiting example, using a matching or classification algorithm. In another embodiment, topic generation component 210 can automatically generate a new topic from the data that is indicative of a topic and associate the new topic to the data item. For example, a news article discussing the creation of a new country named “newcountry” can result in the creation of a new topic titled “newcountry”. In a further embodiment, topic generation component 210 can prompt for user input to specify a topic to associate with the data item, such as in conjunction with a learning algorithm. The data items, topics, and associations between data items and topics can be stored in data store 150. Moreover, it is to be appreciated that a data item can be associated with more than one topic, and that any suitable mechanism for generating and/or associating topics to data items can be employed. Furthermore, it is to be appreciated that a topic can be pre-defined or user specified in any suitable manner by the system or a user identity. Additionally, it is to be understood that a data item can be a topic. For example, a social network posting stating “Movie tonight?” can be a topic.

Continuing with reference to FIG. 2, data item collation component 220 can perform a search for data items associated with the user identity or other user identities and instruct topic generation component 210 to associate the resulting data items with topics. For example, data item collation component 220 can search for data items associated with other user identities that have not been associated with topics by topic generation component 210. In another example, when a new topic is generated by topic generation component 210, data item collation component 220 can search for data items associated with the user identity or other user identities and instruct topic generation component 210 to analyze the data items to identify data items to associate with the new topic.

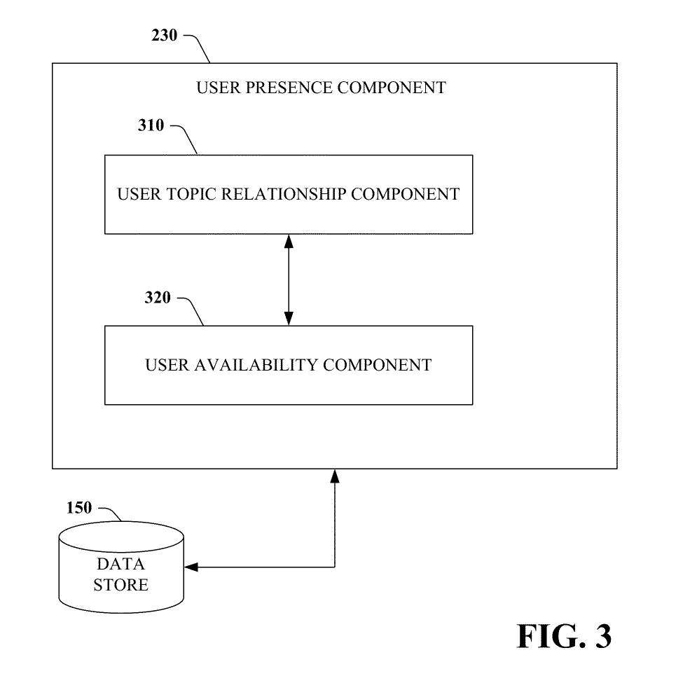

Referring to FIG. 3, user presence component 230 includes user topic relationship component 310 that identifies user identities that have an interest in a topic, such as by using an interest criteria. The interest criteria, for example, can include creation of a data item related to a topic by a user identity, a pre-existing association of a user identity to a data item associated with a topic, a subscription or membership to a data source 170 associated with a topic, browsing history associated with a data source 170 or data item associated with a topic, user specification of interest in a topic, or any other suitable criteria indicative of a user identity having an interest in a topic. Furthermore, user topic relationship component 310 can assign a level on interest to the association between a user identity and a topic. User topic relationship component 310 can associate user identities with topics to which a determination or inference has been made that there is an interest.

User presence component 230 also includes user availability component 320 that determines availability status of a user identity to interact in real time, such as in a non-limiting example, by monitoring applications, devices, and/or systems associated with the user identity. For example, user presence component 230 can monitor online status of a user identity on a social network or chat system (e.g. available, not available, visible, invisible, busy, working, or any other suitable status indication), level or type of activity on a device or application associated with a user identity (e.g., making a call, watching television, listening to music, watching a movie, reading news, drafting a document, working in a spreadsheet, taking pictures, recording video or audio, playing video game, no activity, reading email, not holding device, holding mobile device, device is in motion, device is stationary, looking at device, location of device, speed of location change indicative of driving, running, or walking, or any other suitable indication of level or type of activity on the device or application), location of user identity (e.g. work, home, shopping, library, car, friend's house, or any other suitable location), or any other suitable availability criteria indicative of a user identity's availability to interact in real time. It is to be appreciated that user availability component 320 can employ classification algorithms to classify a user identity's availability to interact in real time into a classification model having multiple levels of availability status. For example, a binary classification can be employed having not available and available classes. In another example, classes can include levels of user engagement with a device, such as, device is off, device is on, holding device, looking at device, and using device. It is to be appreciated that any suitable availability criteria, classification model, and/or algorithm can be employed to classify the user identity's availability to interact in real time.

In a non-limiting example, user presence component 230 can limit identification and determination of availability status to user identities that already have an established relationship with a user identity to which topics, data items, and/or currently available user identities will be presented. In a non-limiting example, an established relationship can include a connection in a social network, an email exchange, a coworker, a part of a direct or extended family, friends, a contact or buddy list, a phone call, a text exchange, a chat message exchange, common membership to a group, common subscription to a publication, or any other suitable criteria indicative of a previously established relationship between two or more user identities. Furthermore, criteria for established relationships can be predefined, dynamically generated, and/or user specified. In addition, user presence component 230 can assign an affinity rating between two user identities based upon one or more established relationships between the two user identities, such as based type of relationship(s) between user identities (e.g. connection in a social network, an email exchange, a coworker, a part of a direct or extended family, friends, a contact or buddy list, a phone call, a text exchange, a chat message exchange, common membership to a group, common subscription to a publication, or any other suitable criteria indicative of a type of previously established relationship between two or more user identities). Moreover, user presence component 230 can weight the type of relationship(s) between user identities, for example, using predefined, dynamically determined, and/or user specified weights. It is to be appreciated that there can be more than one established relationship between two user identities, and a suitable formula or algorithm can be employed to determine the affinity rating, for example, based upon types of established relationships between the two user identities and their associated weights. An affinity rating is an indicator of the strength of the established relationships between two user identities.

Referring back to FIG. 2, topic rating component 240 assigns respective ratings to topics indicative of the user specified and/or inferred likelihood of the topic currently being of interest to a user identity for interaction with one or more other user identities that are currently available. In a non-limiting example, ratings can include relevance to a user identity (e.g., based upon time of day, current activity of the user identity, client device the user identity is employing, location of the user identity, or any other suitable criteria indicative of the relevance of the topic to the user identity), importance of the topic to a set of user identities (e.g., based upon likes of the topic or date items associated with the topic, user identity provided ratings of the topic or data items associated with the topic, inference regarding importance from analysis of the data items associated with the topic, or any other suitable criteria indicative of the importance of the topic to a set of user identities), the number of data items associated with a topic, the number of user identities associated with a topic, the number of user identities associated with a topic and that are currently available to interact in real time, the affinity ratings amongst user identities that are associated with the topic (e.g. the stronger the combination of established relationships amongst the user identities associated with the topic as indicated by the associated affinity ratings, such as by using a suitable formula or algorithm to combine the affinity ratings, the higher the rating of the topic), or any other suitable criteria for indicating likelihood of the topic currently being of interest to a user identity for interaction with other one or more other user identities. Ratings can employ any suitable scale for indicating the relative likelihood of a topic currently being of interest to a user identity for interaction with one or more other user identities that are currently available as compared to other topics. In an embodiment, topic rating component 240 can employ artificial intelligence to infer ratings indicative of the likelihood of a topic currently being of interest to a user identity for interaction with one or more other user identities that are currently available. Furthermore, topic rating component 240 can employ a plurality of criteria with respective ratings and combine them using an algorithm, optionally with weights, to generate an overall rating for a topic. Moreover, rating criteria can be predefined, dynamically determined, and/or user specified criteria. In a non-limiting example, a topic having a higher quantity of associated user identities with availability status indicating available can be rated higher than a topic having a lower quantity of associated user identities with availability status indicating available. In another non-limiting example, a topic having a higher quantity of associated data items can have a higher rating than a topic having a lower quantity of associated data items.

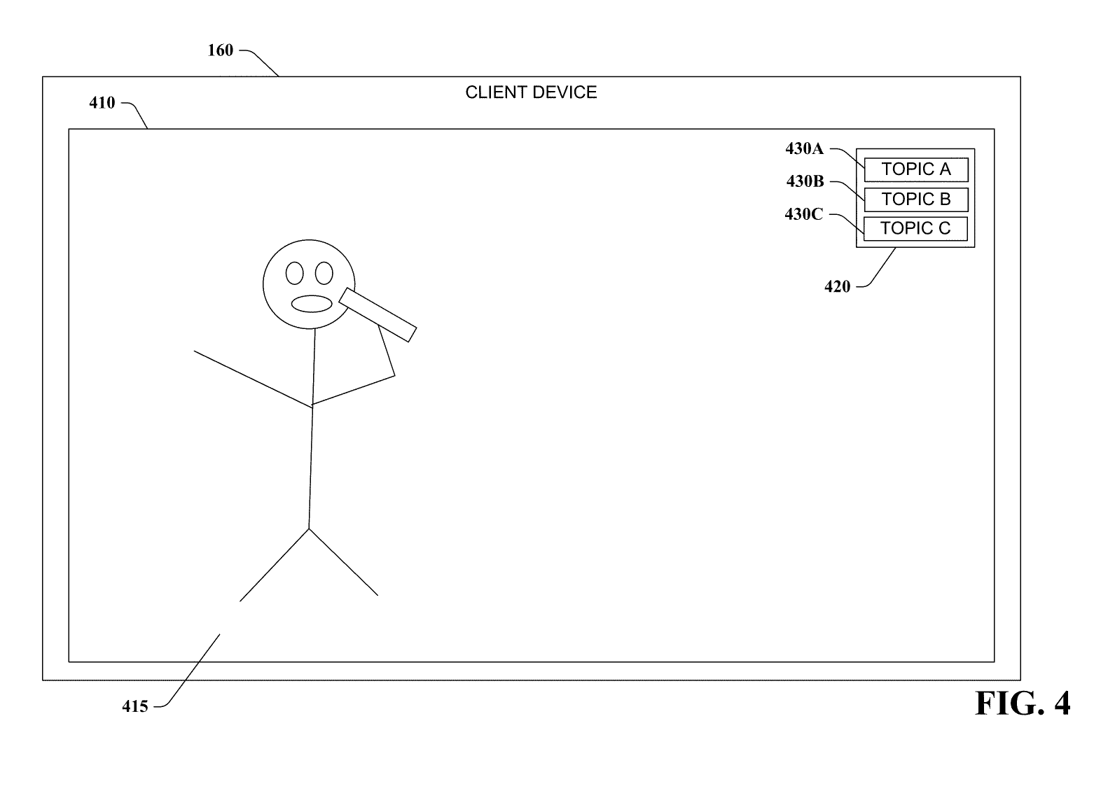

Topic presentation component 250 can generate, for a user identity, a list of topics, one or more data items associated with the respective topics, and/or one or more other user identities associated with the respective topics that are currently available to interact with the user identity. Referring to FIG. 4, in a non-limiting example, a client device 160 associated with a user identity A with a display 410 showing a music television show 415 and having a notification area 420 is depicted. Notification area 420 includes a list of topics: topic A 430A, topic B 430B, and topic C 430C that have been selected for presentation to user identity A by topic presentation component 250. For example, the list can be prioritized, such that topic A 430A can be rated more highly than topic B 430B and topic C 430C, and topic B 430B can be rated more highly than topic C 430C. It is to be appreciated that any suitable criteria, predefined, dynamically determined, and/or user specified, can be employed by topic presentation component 250 for selection of topics based upon their associated ratings, for example, the top N rated topics, where N is an integer or percentage, or the number of topics that will fit into notification area 420, or any other suitable criteria for topic selection. Furthermore, while only three topics are illustrated in this example, any suitable number of topics can be selected by topic presentation component 250 for presentation and can be presented in any suitable order, predefined, dynamically determined, and/or user specified. Additionally, topic A 430A, topic B 430B, and topic C 430C can be presented with their respective associated ratings (not shown). It is further to be appreciated that notification area 420 can have user selectable navigation controls to navigate to any information not currently viewable in notification area 420 (e.g., scroll bars, up button, down button, or any other suitable navigation control). Moreover, any suitable manner for presenting and navigating topics selected by topic presentation component 250 and information associated with the selected topics can be employed.

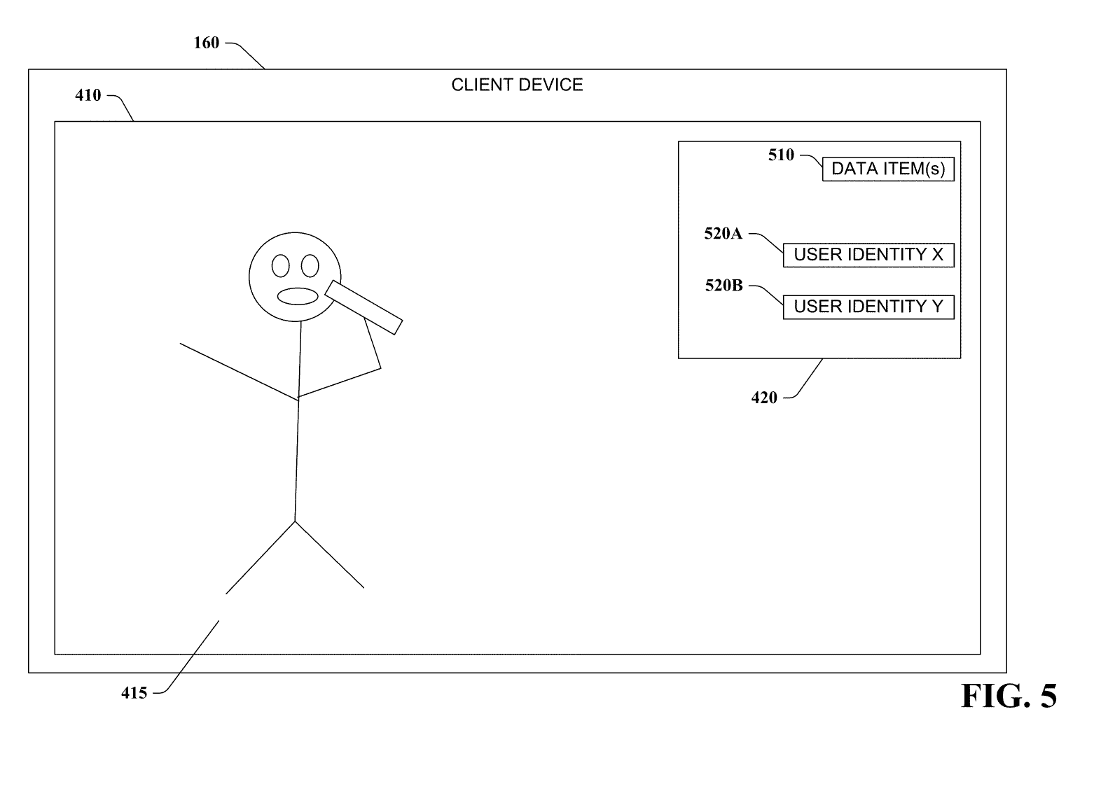

Referring to FIG. 5, in a non-limiting example, a client device 160 associated with a user identity A with a display 410 showing a music television show 415 and having a notification area 420 is depicted. Notification area 420 includes one or more data items 510 associated with a topic selected from topic A 430A, topic B 430B, and topic C 430C from FIG. 4, and user identity X 520A and user identity Y 520B that are currently available to interact with user identity A in real time. In addition, user identity X 520A and user identity Y 520B can be presented with respective indications of their level or classification of availability status (not shown). Furthermore, while only one data item 510 and two user identities 520A and 520B are illustrated in this example, any suitable number of data items 510 and user identities can be selected by topic presentation component 250 for presentation using any suitable selection criteria and can be presented in any suitable order, predefined, dynamically determined, and/or user specified. Additionally, user identities 520A and 520B can be presented with their respective associated levels of interest in the topic (not shown). Furthermore, it is to be appreciated that any suitable manner for presenting and navigating data items and currently available user identities selected by topic presentation component 250 and information associated with the selected data items and currently available user identities can be employed. In another embodiment, the presentation of the list of topics is optional, and topic presentation component 250 can directly present one or more data items 510 and one or more currently available user identities, for example, as depicted in FIG. 5.

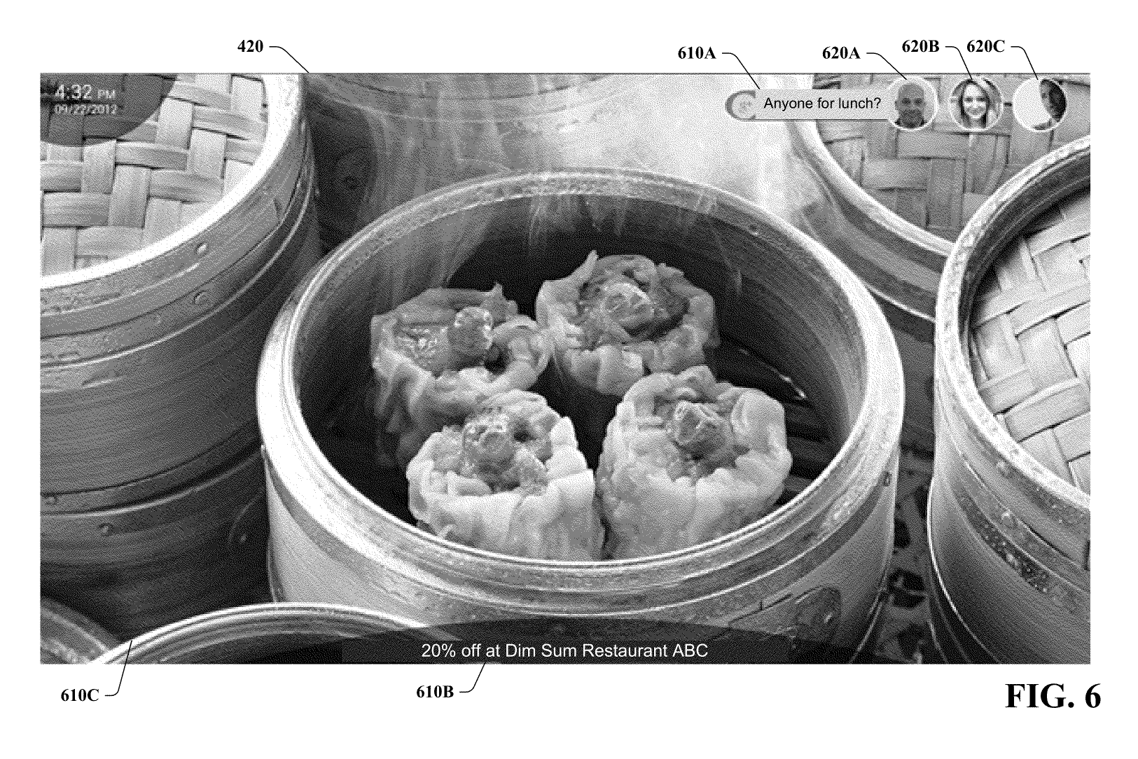

Referring to FIG. 6, in a non-limiting example, a notification area 420 is depicted associated with user identity A. Notification area 420 includes user identity S 620A, user identity T 620B, and user identity U 620C that are currently available to interact with user identity A in real time. Notification area 420 also includes a social network posting data item 610A by user identity S 620A asking “Anyone for lunch?, an advertisement data item 610B for “20% off at Dim Sum Restaurant ABC”, and an image data item 610C of dim sum. In a non-limiting example, the display in notification area 420 can be the result of user identity A selecting a topic, such as lunch or food. In another non-limiting example, the display in notification area 420 can be presented to user identity A without any interaction by user identity A. It is to be appreciated that topics, data items, and/or currently available user identities can be selected and presented by topic presentation component 250 using any suitable criteria, and at any suitable time, predefined, dynamically determined, and/or user specified. Advantageously, topic presentation component 250 can select topics and data items for presentation to a user identity based at least upon the ability of the user identity to interact with other user identities interested in the topics or data items.

Referring back to FIG. 1, client interface component 140 can convey selected topics, data items, currently available user identities, and any other information associated thereto to client device 160 for presentation to a user identity, such as in a non-limiting example, as depicted in FIGS. 4-6. In another embodiment, where information server 110 is on a client device 160, information server 110 can present the selected topics, data items, currently available user identities, and any other information associated thereto.

It is to be appreciated that any selection, determination, matching, classification, or inference criteria, functions, or algorithms discussed herein can employ suitable thresholds that can be predefined, dynamically generated, and/or user specified.

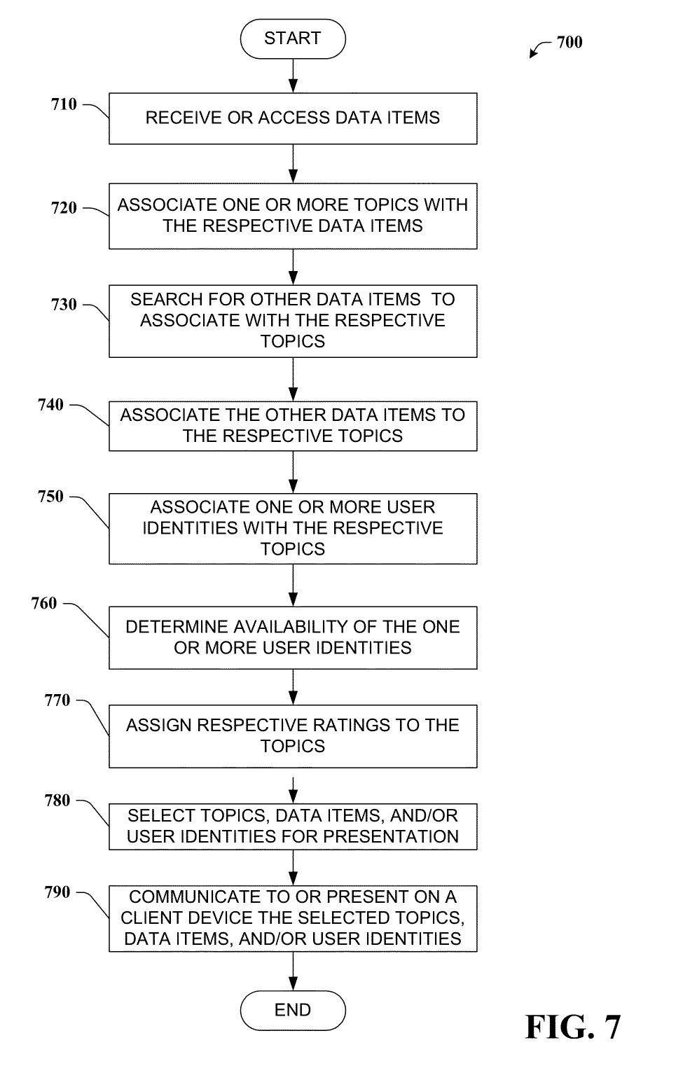

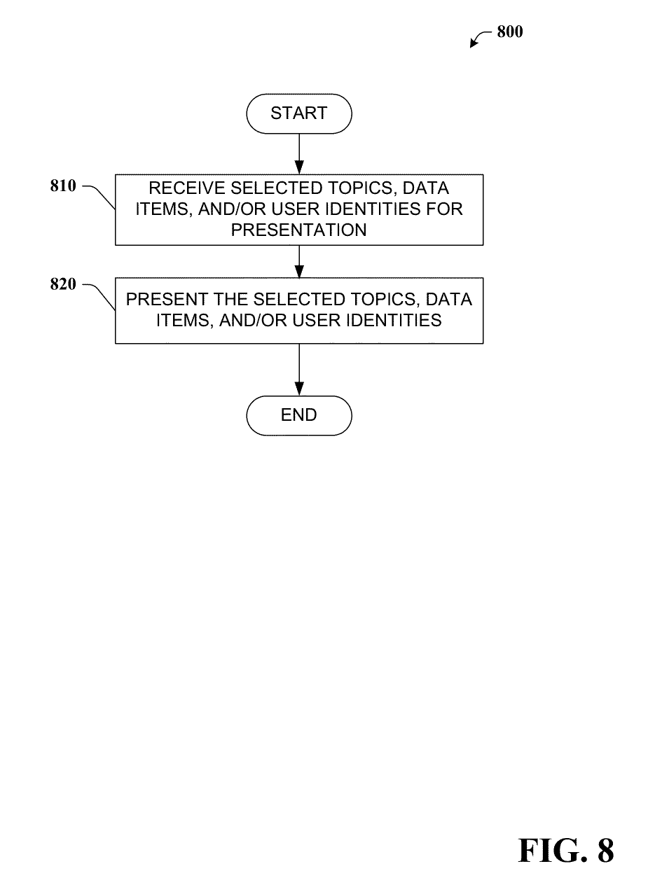

FIGS. 7 and 8 illustrate various methodologies in accordance with certain disclosed aspects. While, for purposes of simplicity of explanation, the methodologies are shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

Referring to FIG. 7, an exemplary method 700 for identifying topics, data items, and/or currently available user identities for presentation to a user identity is depicted. At reference numeral 710, data items are accesses or received from one or more data sources (e.g., by a data source interface component 120, opportunity engine 130, or information server 110). At reference numeral 720, one or more topics are associated with the respective data items (e.g., by a topic generation component 210, opportunity engine 130, or information server 110). At reference numeral 730, a search is conducted for other data items to associated with the respective topics (e.g., by a data item collation component 220, opportunity engine 130, or information server 110). At reference numeral 740, any other data items identified by the search are associated with the respective topics (e.g., by a data item collation component 220, opportunity engine 130, or information server 110). At reference numeral 750, user identities are associated with respective topics in which they have an interest (e.g., by a user topic relationship component 310, user presence component 230, opportunity engine 130, or information server 110). At reference numeral 760, availability status of the user identities is determined (e.g., by a user availability component 320, user presence component 230, opportunity engine 130, or information server 110). At reference numeral 770, ratings are assigned to the topics (e.g., by a topic rating component 240, user presence component 230, opportunity engine 130, or information server 110). At reference numeral 780, topics, data items, and/or currently available user identities are selected for presentation to a user identity (e.g., by a topic presentation component 250, opportunity engine 130, or information server 110). At reference numeral 790, the selected topics, data items, and/or currently available user identities or are presented to a user identity or are conveyed to a client device 160 for presentation (e.g., by a topic presentation component 250, client interface component 140, opportunity engine 130, or information server 110).

Referring to FIG. 8, an exemplary method 800 for receiving and presenting topics, data items, and/or currently available user identities is depicted. At reference numeral 810, topics, data items, and/or currently available user identities (e.g., by a client device 160). At reference numeral 820, the topics, data items, and/or currently available user identities are presented to a user identity (e.g., by a client device 160).

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, tablets, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object 910, 912, etc. or computing objects or devices 920, 922, 924, 926, 928, etc. can also contain an application, such as applications 930, 932, 934, 936, 938, that might make use of an API, or other object, software, firmware and/or hardware, suitable for communication with or implementation of various embodiments of this disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any suitable network infrastructure can be used for exemplary communications made incident to the systems as described in various embodiments herein.

Thus, a host of network topologies and network infrastructures, such as client/server, peer-to-peer, or hybrid architectures, can be utilized. The “client” is a member of a class or group that uses the services of another class or group. A client can be a computer process, e.g., roughly a set of instructions or tasks, that requests a service provided by another program or process. A client process may utilize the requested service without having to “know” all working details about the other program or the service itself.

In a client/server architecture, particularly a networked system, a client can be a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc. provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting transaction services or tasks that may implicate the techniques for systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 940 is the Internet, for example, the computing objects 910, 912, etc. can be Web servers, file servers, media servers, etc. with which the client computing objects or devices 920, 922, 924, 926, 928, etc. communicate via any of a number of known protocols, such as the hypertext transfer protocol (HTTP). Objects 910, 912, etc. may also serve as client computing objects or devices 920, 922, 924, 926, 928, etc., as may be characteristic of a distributed computing environment.

### Exemplary Computing Device

As mentioned, advantageously, the techniques described herein can be applied to any suitable device. It is to be understood, therefore, that handheld, portable and other computing devices and computing objects of all kinds are contemplated for use in connection with the various embodiments. Accordingly, the computer described below in FIG. 10 is but one example of a computing device that can be employed with implementing one or more of the systems or methods shown and described in connection with FIGS. 1-8. Additionally, a suitable server can include one or more aspects of the below computer, such as a media server or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 thus illustrates an example of a suitable computing system environment 1000 in which one or aspects of the embodiments described herein can be implemented, although as made clear above, the computing system environment 1000 is only one example of a suitable computing environment and is not intended to suggest any limitation as to scope of use or functionality. Neither is the computing environment 1000 be interpreted as having any dependency or requirement relating to any one or combination of components illustrated in the exemplary operating environment 1000.

With reference to FIG. 10, an exemplary computing device for implementing one or more embodiments in the form of a computer 1010 is depicted. Components of computer 1010 may include, but are not limited to, a processing unit 1020, a system memory 1030, and a system bus 1022 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, system memory 1030 may also include an operating system, application programs, other program modules, and program data.

A user can enter commands and information into the computer 1010 through input devices 1040, non-limiting examples of which can include a keyboard, keypad, a pointing device, a mouse, stylus, touchpad, touchscreen, trackball, motion detector, camera, microphone, joystick, game pad, scanner, or any other device that allows the user to interact with computer 1010. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such local area network (LAN) or a wide area network (WAN), but may also include other networks/buses e.g., cellular networks.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques described herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the aspects disclosed herein are not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In order to provide for or aid in the numerous inferences described herein (e.g. inferring relationships between metadata or inferring topics of interest to users), components described herein can examine the entirety or a subset of the data to which it is granted access and can provide for reasoning about or infer states of the system, environment, etc. from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

What is claimed is:

1. A method, comprising:
generating, by a device including a processor, a plurality of topics based upon a plurality of data items;
determining, by the device, respective availability statuses of user identities from a plurality of user identities having an established relationship with each other;
rating, by the device, the topics based upon at least the respective availability statuses and respective associations of the user identities with the plurality of topics; and
selecting, by the device, a set of topics from the plurality or topics to present to a user identity of the plurality of user identities based upon the respective ratings of the topics.

2. The method of claim 1, wherein the generating the plurality of topics comprises:
receiving a data item from a data source;
identifying a topic to associated with the data item;
searching at least one of the data source or other data sources to identify other data items related the topic; and
associating the other data items to the topic.

3. The method of claim 1, further comprising associating, by the device, the plurality of user identities with the plurality of topics by identifying respective user identities that have an interest in respective topics based upon the respective user identities associations to data items associated with the respective topic.

4. The method of claim 1, wherein the detecting respective availability statuses of the user identities comprises, for each user identity of the plurality of user identities:
monitoring the user identity for activity;
in response to detecting activity meeting an availability criteria, setting an availability status associated with the user identity to a value indicative of the user identity being available; and
in response to detecting activity not meeting the availability criteria, setting the availability status to a value indicative of the user identity not being available.

5. The method of claim 1, wherein the detecting respective availability statuses of the user identities comprises, for each user identity of the plurality of user identities:
monitoring the user identity to determine a level of activity; and
correlating the level of activity into one of a plurality of values for an availability status associated with the user identity.

6. The method of claim 1, wherein the ratings are further based upon respective quantities of data items of the plurality of data items associated with the respective topic.

7. The method of claim 1, wherein the ratings are further based upon respective relevance of the topics.

8. The method of claim 1, wherein the ratings are further based upon respective importance of the topics.

9. The method of claim 1, wherein topics that have a higher quantity of associated user identities with availability status indicating available have a higher rating than topics that have a lower quantity of associated user identities with availability status indicating available.

10. The method of claim 1, wherein topics that have a higher overall affinity rating amongst respective user identities associated with the topics that have the higher overall affinity rating have a higher rating than topics that have a lower overall affinity rating amongst the respective user identities associated with the topics that have the lower overall affinity rating.

11. The method of claim 1, wherein topics that have a higher quantity of associated data items have a higher rating than topics that have a lower quantity of associated data items.

12. The method of claim 1, wherein the selecting the set of topics comprises selecting the set of topics having associated ratings that meet a rating threshold.

13. The method of claim 1, further comprising presenting the selected set of topics to the user identity.

14. The method of claim 13, where the presented set of topics comprise for each topic:
the topic; and
the user identities associated with the topic having an availability status indicating available.

15. The method of claim 14, where the presented set of topics further comprise for each topic:
one or more data items associated with the topic.

16. The method of claim 13, wherein respective topics of the selected set of topic are presented with indications of respective ratings.

17. A system, comprising:
a processor, communicatively coupled to a memory that stores computer-executable instructions, that executes or facilitates execution of the computer-executable components, comprising:
a topic generation component configured to generate a plurality of topics based upon a plurality of data items;
a user availability component configured to determine respective availability statuses of user identities from a plurality of user identities having an established relationship with each other;
a topic rating component configured to rate the topics based upon at least the respective availability statuses and respective associations of the user identities with the plurality of topics; and
a topic presentation component configured to select a set of topics from the plurality or topics to present to a user identity of the plurality of user identities based upon the respective ratings of the topics.

18. The system of claim 17, wherein the topic generation component is further configured to:
receive a data item from a data source;
identify a topic to associated with the data item;
search at least one of the data source or other data sources to identify other data items related the topic; and
associate the other data items to the topic.

19. The system of claim 17, further comprising a user topic relationship component configured to associate the plurality of user identities with the plurality of topics by identifying respective user identities that have an interest in respective topics based upon the respective user identities associations to data items associated with the respective topic.

20. The system of claim 17, wherein the user availability component is configured to, for each user identity of the plurality of user identities:
monitor a user identity for activity;
in response to detecting activity meeting an availability criteria, setting an availability status associated with the user identity to a value indicative of the user identity being available; and
in response to detecting activity not meeting the availability criteria, setting the availability status to a value indicative of the user identity not being available.

21. The system of claim 17, wherein the user availability component is configured to, for each user identity of the plurality of user identities:
monitor the user identity to determine a level of activity; and
correlate the level of activity into one of a plurality of values for an availability status associated with the user identity.

22. The system of claim 17, wherein the ratings are further based upon respective quantities of data items of the plurality of data items associated with the respective topics.

23. The system of claim 17, wherein topic rating component rates based at least in part upon respective relevance of the topics.

24. The system of claim 17, wherein topic rating component rates based at least in part upon based upon respective importance of the topics.

25. The system of claim 17, wherein the topic rating component rates topics that have a higher quantity of associated user identities with availability status indicating available with a higher rating than topics that have a lower quantity of associated user identities with availability status indicating available.

26. The system of claim 17, wherein the topic rating component rates topics that have a higher overall affinity rating amongst respective user identities associated with the topics that have the higher overall affinity rating higher than topics that have a lower overall affinity rating amongst the respective user identities associated with the topics that have the lower overall affinity rating.

27. The system of claim 17, wherein the topic rating component rates topics that have a higher quantity of associated data items with a higher rating than topics that have a lower quantity of associated data items.

28. The system of claim 17, wherein the topic presentation component is further configured to select the set of topics having associated ratings that meet a rating threshold.

29. The system of claim 17, where the topic presentation component is further configured to present the selected set of topics to the user identity.

30. The system of claim 29, where the presented set of topics comprise for each topic:
the topic; and
the user identities associated with the topic having an availability status indicating available.

31. The system of claim 30, where the presented set of topics further comprise for each topic:
one or more data items associated with the topic.

32. A non-transitory computer-readable medium having instructions stored thereon that, in response to execution, cause at least one device including a processor to perform operations comprising:
generating a plurality of topics based upon a plurality of data items;
determining respective availability statuses of user identities from a plurality of user identities having an established relationship with each other;
rating the topics based upon at least the respective availability statuses and respective associations of the user identities with the plurality of topics; and
selecting a set of topics from the plurality or topics to present to a user identity of the plurality of user identities based upon the respective ratings of the topics.
